(19) United States
(12) Patent Application Publication
(10) Pub. No.: US 2018/0088662 A1
(43) Pub. Date: Mar. 29, 2018

(54) INPUT DEVICE FOR CONTROLLING AN AVATAR IN A COMPUTER-GENERATED ENVIRONMENT, AND A METHOD FOR CONTROLLING SAME

(71) Applicant: PATHBENDER GMBH, Ronnenberg (DE)

(72) Inventors: Julia REINEKE, Ronnenberg (DE); Tobias REINEKE, Ronnenberg (DE)

(73) Assignee: PATHBENDER GMBH, Ronnenberg (DE)

(21) Appl. No.: 15/558,733

(22) PCT Filed: May 24, 2016
(86) PCT No.: PCT/EP2016/000860

§ 371 Date: Sep. 15, 2017

(30) Foreign Application Priority Data
Jun. 16, 2015 (DE) 10 2015 007 728.7

(51) Int. Cl. G06F 3/01

(52) U.S. Cl. CPC G06F 3/011; G06F 2203/012

(57) ABSTRACT

The invention relates to an input device for creating and controlling an avatar in a computer-generated environment, and to a method for controlling same. The immersion into the virtual reality is increased by virtue of the claimed input device and the method for controlling same allowing the user natural movement, without spatial limits, in a familiar form and with authentic solidity.

### SUMMARY

The invention relates to an input device for controlling an avatar in a computer-generated environment and a method for controlling same. In a virtual reality environment the immersion is increased by virtue of the claimed input device and the method for controlling same, allowing the user a natural walking experience, without spatial limits, with a familiar anatomy and an authentic feeling of body presence.

### DESCRIPTION

The present invention relates to an input device for control of an avatar in a computer-generated environment and method for controlling same.

As the closest prior art, JP2001171815A (among others) discloses a device comprising a stationary conveyor belt with a rotatable guide on top and containing rolling elements which provide a walkable surface for a person.

The apparatus shown is equipped with a two-dimensional position control. If the person moves away from the center of the guide in either direction, the device responds with a special maneuver. This maneuver involves a rotation of the guide and/or a transport movement of the conveyor belt and always transports the person back to the center of the walkable area. The kinematics of JP2001171815A (and also of all similar devices) will be illustrated by the following simple examples. If the person turns in place in the center of the guide, the device does not respond because the rotation angle of the person is irrelevant to the position control. However, in case of the person walking transversely to the transport direction of the conveyor belt, the person is rotated by the guide so that the walking direction is aligned again with the transport direction of the conveyor belt, and thus the conveyor belt is able to convey the person back to the center of the walkable area. This type of control is advantageous because it enables the person to walk without limits in any direction. At the same time this type of control is unfavorable, since it rotates the person in an unexpected way when walking transversely to the transport direction of the conveyor belt, which may result in the walker feeling queasy. In case of the device providing just a small guide with a limited walkable surface, this rotation response has to be quick and promptly to prevent the person from leave the walkable area unintentionally. The object of the present invention is to avoid the disadvantages of JP2001171815A in terms of comfort, which especially occur for a small and economical to manufacture device having only a small-sized walkable surfaces. The object of the present invention is achieved by restricting the walker in his freedom of movement in a way that may be nonsensical to the expert.

The solution of the problem is disclosed in claim 1 of the present invention, in which the two-dimensional position control according to the prior art is replaced by a one-dimensional position control in combination with an angle control. In contrast to the prior art, the device of the present invention has an entirely different kinematics, because it reacts immediately to the angular orientation of the person on the walkable surface. However, with the device of the present invention it is not possible to walk transversely to the frontal direction of the person. In contrast to the prior art, especially a lateral movement by unlimited side-steps is no longer possible with the present invention.

The input device of the present invention features a device for acquiring depth and color information and utilizes these abilities and enables the creation and control of an avatar having the same shape and appearance as the person (7).

The advantages of the subject disclosed in claim 1 are based on a different kind of control method which always provides a comfortable walking experience, especially when the walkable surface of the device is small. In addition, the inventive device offers the possibility to enter a virtual world with an authentic feeling of body presence and completely control the avatars limbs by means of a body joint tracking of the person located on the device.

The comfort while walking in virtual reality could be enhanced even further, using a soft-elastic enclosure around the walker's hip or thighs. It is also advantageous if the inventive device compensates for instinctive “lean back” during braking or “laterally tilting” during cornering with a sensitive but nimble tilting of the walking surface about horizontal axes. The tilting of the walking surface is then also used for the simulation of inclination in a virtual environment. Supplying some objects or obstacles from the virtual reality also in the real environment as a dummy, approaching the user from the proper direction and distance and with the proper speed, for example by a hinged bracket with corresponding attachments at its end, is another possibility to enhance the immersion in the virtual environment.

The invention is explained in more detail below with reference to the drawings.

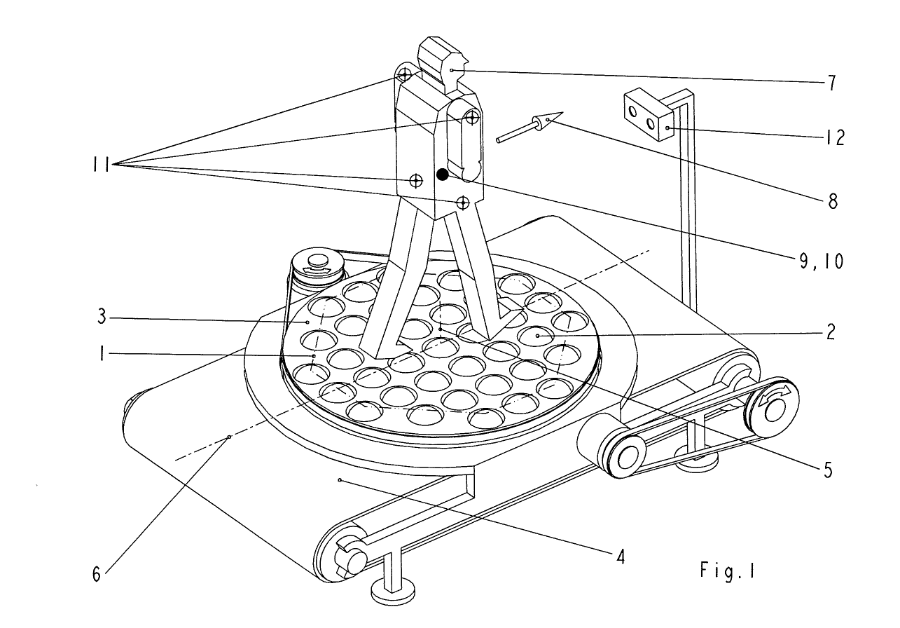

FIG. 1 shows the input device according to the invention in a highly simplified illustration with the conveyor belt, the guide with rolling bodies, the drives and detection means as well as the person with some of the possible body joints.

The rolling bodies (2) protrude from the top of the guide (3) and form the walkable surface (1) on which a person (7) is walking or standing. If the person (7) is located in the center of the guide (3) and performs a rotation in place, the guide (3) always and immediately executes a counter-rotation, which completely compensates the rotation of the person (7) so that the person indeed fulfills the necessary body movements for a rotation but without the person actually turning around. The walking direction (8) of the person (7) is thus always parallel to the longitudinal center line (6) of the conveying device (4) and during walking the person (7) is simply and directly centered in the middle of the guide (3) by means of a usual one-dimensional position control. Instead of being exposed to violent and unexpected reactions, the persons (7) is always at rest in regard to their position and angular orientation compared to the real physical environment while turning in place or while walking straight and in curves. The angular orientation of the person (7) is (for example) calculated from their posture by means of the position of their body joints (11). Advantageously, the positions of each individual body joint (11) is also be used to control the limbs of the avatar in the virtual environment. It is particularly advantageous that during avatar control the person (7) always keeps the same frontal orientation in regard to the detection means (12). For a most authentic avatar design, the detection means (12) is simultaneously detecting depth information and detailed color information of the person (7) on the walking surface (1), which are transferred to the 3D model of the avatar. For this purpose, the person (7) is standing in the center of the walking area (1) and is rotated in front of the detection device (12) by means of the rotatable guide (3). During this scan process, neither a translational movement of the person (7) nor an avatar control is performed.

A lateral offset of the person (7) is not directly influenced by the inventive device, since the input device does not have a linear actuator transverse to the longitudinal center line (6). The lateral offset remains unchanged if the person (7) walks parallel to the longitudinal center line (6) on the walkable surface (1). However, the lateral offset is changing if the person (7) on the walkable surface (1) is walking obliquely to the longitudinal center line (6). The lateral offset is therefore reduced, by adding an offset to the angular orientation of the guide (3) in a suitable manner, so that the walking direction (8) of the person (7) always obliquely points towards the longitudinal center line (6), namely as long as the lateral offset is present. The amount of this angular offset and its sign are based on the orientation and the value of the persons lateral offset.

If there is no transport movement induced by the conveying device (4), the rotational center of the guide (3) and the rotational center of the walking surface (1) are located coincident in the center of the guide (3). If the person (7) is located laterally thereof, the rotational center of the walking surface (1) is shifted by the amount of the persons lateral offset towards the position of the person (7), by means of an addition of the velocity vectors of the guide rotation and the velocity vectors of the transport movement of the conveying device (4). The basis for this is the fact that a velocity vector addition of a rotation and a translation in the same plane again results in a rotation with the same angular velocity, but with the pivot point displaced orthogonally to the direction of translation. In case of a person rotating in a laterally offset position on the walking surface (1), the conveying device (4) performs a defined transport movement in addition to the rotation of the guide (3), whereby as a result the pivot point of the walking surface (1), viewed along the longitudinal center line (6), is positioned perpendicular to the position of the person (7).

### LIST OF REFERENCE NUMBERS

1 walking surface
2 rolling bodies
3 guide
4 conveying device
5 axis of rotation (of the guide)
6 longitudinal center line (of the conveyor)
7 person
8 walking direction
9 linear control point
10 lateral control point
11 body joints
12 detection means

1. An input device for controlling an avatar in a computer-generated environment, comprising:
a guide including a plurality of rolling bodies distributed within openings in the guide and the rolling bodies providing a walkable surface, wherein each of the plurality of rolling bodies may roll in any direction within its respective opening in the guide;
a stationary conveying device located below the walkable surface and which conveys in one dimension, wherein at least some of the rolling bodies contact or are movable into contact with the conveying device;
means for detecting an orientation of a person on the walkable surface; and
means for rotating the guide relative to the conveying device about an axis of rotation which is perpendicular to the walkable surface, wherein the means for rotating is configured to rotate the guide based on changes in the orientation of the person on the walkable surface detected by the means for detecting.

2. The input device according to claim 1, wherein the means for detecting is configured to acquire a spatial body posture of the person on the walkable surface including depth information for body joints of the person on the walkable surface.

3. The input device according to claim 1, further comprising means for pivot point detection, and wherein a rotational center of the walkable surface is displaceable about a lateral deviation of the person on the walkable surface from the axis of rotation viewed along a longitudinal center line passing through the walkable surface and which coincides with the one dimension of the conveying device.

4. The input device according to claim 1 further comprising means for acquiring color information, limb information, and depth information of the person on the walkable surface.

5. (canceled)

6. The method of claim 12, further comprising the step of sensing spatial body posture of the person including depth information and outputting the sensed information to the computer.

7-11. (canceled)

12. A method for providing input to control an avatar in a computer-generated environment, comprising the steps of:
providing an input device which includes
a guide including a plurality of rolling bodies distributed within openings in the guide and the rolling bodies providing a walkable surface, wherein each of the rolling bodied may roll in any direction within its respective opening in the guide;
a stationary conveying device located below the walkable surface and which conveys in one dimension, wherein at least some of the rolling bodies contact or are movable into contact with the conveying device;
means for detecting an orientation of a person on the walkable surface; and
means for rotating the guide relative to the conveying device about an axis of rotation that is perpendicular to the walkable surface, wherein the means for rotating is configured to rotate the guide based on changes in the orientation of the person on the walkable surface detected by the means for detecting;
sensing a person walking on the walkable surface and any changes in orientation of the person which take place while the person is walking on the walkable surface;
rotating the guide about the axis of rotation based on changes in the orientation of the person walking on the walkable surface such that, after changes in the orientation of the person, walking continues in line with the one dimension of the conveying device; and
outputting information pertaining to walking sensed in the sensing step and rotational changes which occur during the rotating step to a computer.
